(19) United States
(12) Patent Application Publication
(10) Pub. No.: US 2023/0351412 A1
(43) Pub. Date: Nov. 2, 2023

(54) INFORMATION PROCESSING APPARATUS, INFORMATION PROCESSING METHOD, INFORMATION PROCESSING PROGRAM, AND INFORMATION PROCESSING SYSTEM

(71) Applicant: SONY GROUP CORPORATION, TOKYO (JP)

(72) Inventor: YU TANAKA, TOKYO (JP)

(21) Appl. No.: 17/928,523

(22) PCT Filed: Jun. 4, 2021
(86) PCT No.: PCT/JP2021/021307

§ 371 Date: Nov. 29, 2022

(30) Foreign Application Priority Data
Jun. 11, 2020 (JP) 2020-101367

(51) Int. Cl. G06Q 30/018; G06Q 20/40; G06V 10/44; G06T 3/40; G06T 7/11; G06V 10/74; G06V 10/80

(52) U.S. Cl. CPC G06Q 30/0185; G06Q 20/40145; G06T 3/40; G06T 7/11; G06V 10/44; G06V 10/761; G06V 10/806

(57) ABSTRACT

An information processing apparatus (100) includes: a personal authentication unit (111) that performs personal authentication of a seller; and a product identification unit (112) that identifies whether a received product received by a purchaser of an authentic product posted for selling by the seller who has undergone the personal authentication matches the authentic product based on a product feature of the authentic product and a product feature of the received product.

### FIELD

The present disclosure relates to an information processing apparatus, an information processing method, an information processing program, and an information processing system.

### BACKGROUND

There is a known technique of promoting secondary distribution. For example, there is a proposed technology of automatically generating selling product information, which is used when selling a product using an e-commerce platform, based on purchase information at the time of product purchase.

### CITATION LIST

### Patent Literature

Patent Literature 1: JP 6472151 B2

### SUMMARY

### Technical Problem

However, with the above-described known technique, it is not necessarily possible to improve usability in secondary distribution services. For example, the above-described known technology simply provides automatic generation of selling product information, which is used at the time of selling a product using the e-commerce platform, based on the purchase information at the time of purchasing the product, and cannot always improve the usability in the secondary distribution services.

In view of this, the present disclosure proposes an information processing apparatus, an information processing method, an information processing program, and an information processing system capable of improving usability in secondary distribution services.

To solve the above problem, an information processing apparatus includes: a personal authentication unit that performs personal authentication of a seller; and a product identification unit that identifies whether a received product received by a purchaser of an authentic product posted for selling by the seller who has undergone the personal authentication matches the authentic product based on a product feature of the authentic product and a product feature of the received product.

### BRIEF DESCRIPTION OF DRAWINGS

FIG. 1 is a diagram illustrating a subject related to a secondary distribution service according to an embodiment of the present disclosure.

FIG. 2 is a diagram illustrating a configuration example of an information processing system according to the embodiment.

FIG. 3 is a diagram illustrating a configuration example of a seller device according to the embodiment.

FIG. 4 is a diagram illustrating a configuration example of a purchaser device according to the embodiment.

FIG. 5 is a diagram illustrating a configuration example of an information processing apparatus according to the embodiment.

FIG. 6 is a diagram illustrating an example of a product identification information database according to the embodiment.

FIG. 7 is a diagram illustrating an example of a personal authentication information database according to the embodiment.

FIG. 8 is a sequence diagram illustrating an example of a selling process according to the embodiment.

FIG. 9 is a sequence diagram illustrating an example of a reception process according to the embodiment.

FIG. 10 is a diagram illustrating a configuration example of a personal authentication information acquisition function according to the embodiment.

FIG. 11 is a flowchart illustrating an example of product identification process according to the embodiment.

FIG. 12 is a diagram illustrating an example of a guidance process according to the embodiment.

FIG. 13 is a diagram illustrating an example of the guidance process according to the embodiment.

FIG. 14 is a flowchart illustrating an example of a product identification process according to the embodiment.

FIG. 15 is a diagram illustrating an example of a target frame determination process according to the embodiment.

FIG. 16 is a diagram illustrating an example of the guidance process according to the embodiment.

FIG. 17 is a flowchart illustrating an example of product identification process according to the embodiment.

FIG. 18 is a diagram illustrating an example of the guidance process according to the embodiment.

FIG. 19 is a diagram illustrating an example of a data recording process according to the embodiment.

FIG. 20 is a diagram illustrating an example of a selling process flow according to the embodiment.

FIG. 21 is a diagram illustrating an example of a purchase process flow according to the embodiment.

FIG. 22 is a diagram illustrating an example of a reception process flow according to the embodiment.

FIG. 23 is a sequence diagram illustrating an example of a selling process according to a modification.

FIG. 24 is a sequence diagram illustrating an example of a reception process according to a modification.

FIG. 25 is a diagram illustrating an example of a screen prompting a user to input information according to a modification.

FIG. 26 is a hardware configuration diagram illustrating an example of a computer that implements functions of the information processing apparatus.

### DESCRIPTION OF EMBODIMENTS

Embodiments of the present disclosure will be described below in detail with reference to the drawings. In each of the following embodiments, the same parts are denoted by the same reference numerals, and a repetitive description thereof will be omitted.

The present disclosure will be described in the following order.
1. Introduction
2. Embodiments
   2-1. Configuration of information processing system
   2-2. Configuration of seller device
   2-3. Configuration of purchaser device
   2-4. Configuration of information processing apparatus
   2-5. Operation example of information processing system
   2-5-1. Selling process
   2-5-2. Reception process
   2-5-3. Personal authentication information acquisition process
   2-5-4. Product identification process
   2-5-5. Data recording process
   2-5-6. Use case
3. Modification
   3-1. Information input
   3-2. Product identification process
4. Summary
5. Hardware configuration

### 1. Introduction

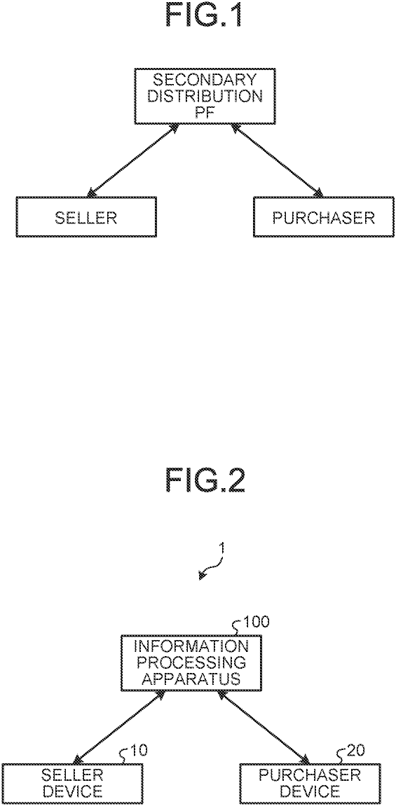

First, a subject related to a secondary distribution service will be described with reference to FIG. 1. FIG. 1 is a diagram illustrating a subject related to a secondary distribution service according to an embodiment of the present disclosure. As illustrated in FIG. 1, subjects related to the secondary distribution service are a seller, a purchaser, and a secondary distribution platform. The secondary distribution platform provides an e-commerce platform in which a product is traded, that is, bought and sold via a network between a seller who wishes to sell the product and a purchaser who wishes to purchase the product. The seller sells s product through the secondary distribution platform. The purchaser purchases a product through the secondary distribution platform.

In this manner, the secondary distribution is a form in which a transaction is performed between individuals without intervening a store. Generally, an individual such as a seller or a purchaser is considered to have lower credibility in transaction compared to a store. This makes it necessary for the secondary distribution service to guarantee the credibility of an individual by some means. In addition, since the secondary distribution is a form in which products are traded without intervening a store, it is considered that counterfeit products such as copy products and fake brand products are likely to be distributed. This makes it necessary for the secondary distribution service to prevent distribution of counterfeit products by some means.

In view of these, the information processing apparatus according to the present invention performs personal authentication of the seller when accepting their post for selling. With this configuration, the information processing apparatus confirms the identity of the seller at the time of selling the product, making it possible to guarantee the credibility of the seller. In addition, the information processing apparatus identifies whether a received product received by a purchaser of an authentic product posted for selling by the seller who has undergone the personal authentication matches the authentic product based on a product feature of the authentic product and a product feature of the received product. With this identification, the information processing apparatus confirms whether the received product is an authentic product when receiving the product, making it possible to prevent the purchaser from receiving a non-authentic product. That is, the information processing apparatus can prevent distribution of counterfeit products. This makes it possible for the information processing apparatus to improve usability in secondary distribution services.

### 2. Embodiments

### 1. Configuration of Information Processing System]

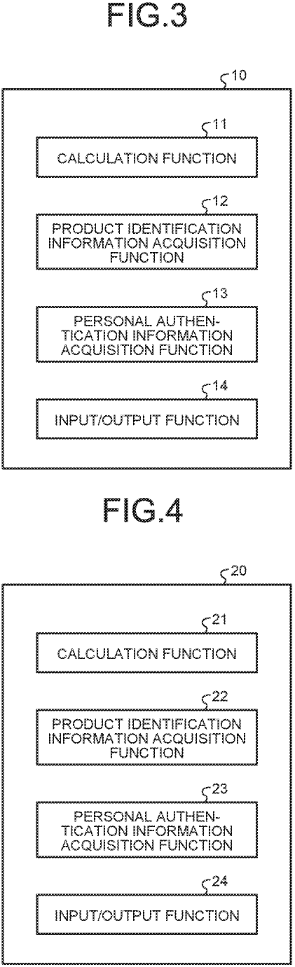

Next, an example of a configuration of an information processing system according to an embodiment of the present disclosure will be described with reference to FIG. 2. FIG. 2 is a diagram illustrating a configuration example of the information processing system according to the embodiment of the present disclosure. As illustrated in FIG. 2, the information processing system 1 according to the embodiment of the present disclosure includes a seller device 10, a purchaser device 20, and an information processing apparatus 100. Note that the information processing system 1 may include an external information processing apparatus such as a terminal device used by a system administrator. These various devices are communicably connected by a wired or wireless connection via a network (for example, the Internet). Note that the information processing system 1 illustrated in FIG. 3 may include any number of seller devices 10, any number of purchaser devices 20, and any number of information processing apparatuses 100.

The seller device 10 is an information processing apparatus used by a seller. The seller device 10 is implemented by, for example, a smartphone, a tablet terminal, a laptop personal computer (PC), a desktop PC, a mobile phone, a personal digital assistant (PDA), or the like. In addition, the seller device 10 captures a product video regarding an authentic product posted for selling by the seller, and extracts a product feature of an image included in the captured product video. Specifically, the seller device 10 divides an image included in the captured product video into a plurality of sections, and extracts a product feature for each of the divided sections.

The purchaser device 20 is an information processing apparatus used by a purchaser. The purchaser device 20 is implemented by, for example, a smartphone, a tablet terminal, a laptop personal computer (PC), a desktop PC, a mobile phone, a personal digital assistant (PDA), or the like. In addition, the purchaser device 20 captures a product video regarding a received product received by the purchaser who has purchased an authentic product, and extracts a product feature of the image included in the captured product video. Specifically, the purchaser device divides an image included in the captured product video into a plurality of sections, and extracts a product feature for each of the divided sections.

The information processing apparatus 100 is a server device that provides a secondary distribution platform. The information processing apparatus 100 provides an e-commerce platform in which a product is traded, that is, bought and sold via a network between a seller who wishes to sell the product and a purchaser who wishes to purchase the product. In addition, the information processing apparatus 100 identifies whether the received product matches the authentic product based on a product feature of the authentic product extracted by the seller device 10 and the product feature of the received product extracted by the purchaser device 20.

### 2. Configuration of Seller Device]

Next, a configuration of the seller device according to the embodiment of the present disclosure will be described with reference to FIG. 3. FIG. 3 is a diagram illustrating a configuration example of the seller device according to the embodiment of the present disclosure. As illustrated in FIG. 3, the seller device 10 includes a calculation function 11, a product identification information acquisition function 12, a personal authentication information acquisition function 13, and an input/output function 14.

The calculation function 11 is actualized by execution of various programs (corresponding to an example of an information processing program) stored in a storage device inside the seller device 10 by a central processing unit (CPU), a micro processing unit (MPU), or the like, using RAM as a work area. Furthermore, the calculation function 11 is actualized by, for example, an integrated circuit such as an application specific integrated circuit (ASIC) or a field programmable gate array (FPGA).

The product identification information acquisition function 12 is actualized by an imaging device such as a small camera mounted on the seller device 10 which is a smartphone, for example. Specifically, the product identification information acquisition function 12 captures an image of a product to be posted to sell according to an operation received from the seller via an input function. Subsequently, the product identification information acquisition function 12 acquires a video of the product (hereinafter, also referred to as a product video) captured by the imaging device.

Subsequently, the product identification information acquisition function 12 acquires still image data (hereinafter, also referred to as image data) at a predetermined time from the product video, and performs recognition processing on the acquired image data using a general object recognition technology. For example, the product identification information acquisition function 12 may include a recognition model such as a deep neural network (DNN) pretrained using predetermined training data by machine learning, and may perform recognition processing using the recognition model on the image data acquired from the imaging device.

More specifically, the product identification information acquisition function 12 calculates a feature being distribution of feature points in the entire image data. Subsequently, the product identification information acquisition function 12 divides the acquired image data into a plurality of sections (hereinafter, also referred to as a mesh). Note that the product identification information acquisition function 12 may cut out a portion (for example, the central portion of the image) highly possible to include the entire product in the acquired image data, and may divide the cut out portion into a plurality of sections. Subsequently, the product identification information acquisition function 12 calculates a feature being distribution of feature points in each section.

In this manner, the product identification information acquisition function 12 calculates the feature for each resolution of the image data. For example, when dividing the acquired image data into a plurality of sections, the product identification information acquisition function 12 calculates the feature in each step while increasing the number of sections stepwise. For example, the product identification information acquisition function 12 divides the acquired image data into six sections, and calculates the feature being distribution of feature points in each of the six divided sections. In addition, the product identification information acquisition function 12 divides the acquired image data into eight sections, and calculates the feature being distribution of feature points in each of the eight divided sections. In addition, the product identification information acquisition function 12 divides the acquired image data into ten sections, and calculates the feature being distribution of feature points in each of the ten divided sections.

Subsequently, the product identification information acquisition function 12 calculates the similarity between the features for each section. Subsequently, the product identification information acquisition function 12 determines a section having a feature that is not similar to any of the features of the other sections, as a target frame, that is, a section including a characteristic portion of the product. Here, the characteristic portion of the product refers to, for example, a portion having higher distinguishability in identification of the product than other portions.

The personal authentication information acquisition function 13 is actualized by, for example, an imaging device such as a small camera mounted on the seller device 10 which is a smartphone, or a fingerprint authentication sensor mounted on a shooting button of the camera. Specifically, when the seller captures an image of a product to be posted to sell, the personal authentication information acquisition function 13 acquires fingerprint data of the seller as personal authentication information from a fingerprint authentication sensor mounted on a shooting button of a camera. Alternatively, the personal authentication information acquisition function 13 acquires image data of the seller’s face or image data of seller’s iris as the personal authentication information by a camera mounted on an upper part of the screen side of the smartphone. In this manner, the personal authentication information acquisition function 13 acquires seller’s biometric information as the personal authentication information by the sensor mounted on the seller device 10.

The input function of the input/output function 14 receives various operations from the seller. For example, the input function is implemented by a keyboard, a mouse, an operation key, and the like. The output function of the input/output function 14 is a display device for displaying various types of information, that is, a screen. For example, the output function is implemented by a liquid crystal display or the like. When a touch panel is adopted in the seller device 10, the input function and the output function are integrated. In the following description, the output function may be referred to as a screen.

### 3. Configuration of Purchaser Device]

Next, a configuration of the purchaser device according to the disclosed embodiment will be described with reference to FIG. 4. FIG. 4 is a diagram illustrating a configuration example of the purchaser device according to the embodiment of the present disclosure. As illustrated in FIG. 4, the purchaser device 20 includes a calculation function 21, a product identification information acquisition function 22, a personal authentication information acquisition function 23, and an input/output function 24.

The calculation function 21 is implemented by execution of various programs (corresponding to an example of an information processing program) stored in a storage device inside the purchaser device 20, by a CPU, an MPU, or the like using RAM as a work area, for example. Furthermore, the calculation function 21 is implemented by an integrated circuit such as ASIC or FPGA.

The product identification information acquisition function 22 is actualized by an imaging device such as a small camera mounted on the purchaser device 20 which is a smartphone, for example. Specifically, the product identification information acquisition function 22 captures an image of a product received by the purchaser according to an operation received from the purchaser via an input function. Subsequently, the product identification information acquisition function 22 acquires a product video captured by the imaging device.

Subsequently, the product identification information acquisition function 22 acquires still image data (hereinafter, also referred to as image data) at a predetermined time from the product video, and performs recognition processing on the acquired image data using a general object recognition technology. For example, the product identification information acquisition function 22 may include a recognition model such as a DNN pretrained using predetermined training data by machine learning, and may perform recognition processing using the recognition model on the image data acquired from the imaging device.

More specifically, the product identification information acquisition function 22 calculates the feature being distribution of feature points in the entire image data. Subsequently, the product identification information acquisition function 22 divides the acquired image data into a plurality of sections. Note that the product identification information acquisition function 22 may cut out a portion (for example, the central portion of the image) highly possible to include the entire product in the acquired image data, and may divide the cut out portion into a plurality of sections. Subsequently, the product identification information acquisition function 22 calculates the feature being distribution of feature points in each section. Having acquired the feature in each section, the product identification information acquisition function 22 transmits information regarding the acquired feature to the information processing apparatus 100. In this manner, the product identification information acquisition function 22 calculates the feature for each resolution of the image data.

Subsequently, the product identification information acquisition function 22 calculates the similarity between the features for each section. Subsequently, the product identification information acquisition function 22 determines a section having a feature that is not similar to any of the features of the other sections as a target frame, that is, a section including a characteristic portion of the product.

The personal authentication information acquisition function 23 is actualized by, for example, an imaging device such as a small camera mounted on the purchaser device 20 which is a smartphone, or a fingerprint authentication sensor mounted on a shooting button of the camera. Specifically, when a product received by the purchaser is imaged, the personal authentication information acquisition function 23 acquires fingerprint data of the purchaser as personal authentication information from a fingerprint authentication sensor mounted on a shooting button of a camera. Alternatively, the personal authentication information acquisition function 23 acquires image data of the purchaser’s face or image data of purchaser’s iris as the personal authentication information by a camera mounted on an upper part of the screen side of the smartphone. In this manner, the personal authentication information acquisition function 23 acquires purchaser’s biometric information as the personal authentication information by the sensor mounted on the purchaser device 20.

The input function of the input/output function 24 receives various operations from the purchaser. For example, the input function is implemented by a keyboard, a mouse, an operation key, and the like. The output function of the input/output function 24 is a display device for displaying various types of information, that is, a screen. For example, the output function is implemented by a liquid crystal display or the like. When a touch panel is adopted in the purchaser device 20, the input function and the output function are integrated. In the following description, the output function may be referred to as a screen.

### 4. Configuration of Information Processing Apparatus]

Next, a configuration of the information processing apparatus according to the embodiment of the present disclosure will be described with reference to FIG. 5. FIG. 5 is a diagram illustrating a configuration example of the information processing apparatus according to the embodiment of the present disclosure. As illustrated in FIG. 5, the information processing apparatus 100 includes a calculation processing function 110 and a database function 120.

The calculation processing function 110 is implemented by execution of various programs (corresponding to an example of an information processing program) stored in a storage device inside the information processing apparatus 100, by a CPU, an MPU, or the like using RAM as a work area, for example. Furthermore, the calculation processing function 110 is implemented by an integrated circuit such as ASIC or FPGA.

The calculation processing function 110 includes a personal authentication unit 111, a product identification unit 112, a guidance unit 113, an output unit 114, an acquisition unit 115, a storage unit 116, and an update unit 117, and implements or executes operations of information processing described below.

The personal authentication unit 111 performs personal authentication of the seller. Specifically, when having acquired the personal authentication information of the seller from the seller device 10 of the seller, the personal authentication unit 111 collates the acquired personal authentication information of the seller with the personal authentication information of the seller acquired in advance from the seller device 10 of the seller, and performs personal authentication of the seller based on the collation. More specifically, when having acquired the personal authentication information of the seller from the seller device 10, the personal authentication unit 111 performs personal authentication by collating the acquired personal authentication information with the personal authentication information of the seller registered in a personal authentication information database 122 in association with seller ID. For example, the personal authentication unit 111 performs personal authentication of the seller based on personal authentication information, represented by fingerprint information, iris information, or face information of the seller.

In addition, the personal authentication unit 111 performs personal authentication of the purchaser. Specifically, when having acquired the personal authentication information of the purchaser from the purchaser device 20 of the purchaser, the personal authentication unit 111 performs personal authentication of the purchaser by collating the acquired personal authentication information of the purchaser with the personal authentication information of the purchaser acquired in advance from the purchaser device 20 of the purchaser. More specifically, when having acquired the personal authentication information of the purchaser from the purchaser device 20, the personal authentication unit 111 performs personal authentication by collating the acquired personal authentication information with the personal authentication information of the purchaser registered in the personal authentication information database 122 in association with purchaser ID. For example, the personal authentication unit 111 performs personal authentication of the purchaser based on personal authentication information, represented by fingerprint information, iris information, or face information of the purchaser.

In addition, the product identification unit 112 identifies whether a received product received by a purchaser of an authentic product posted for selling by the seller who has undergone the personal authentication matches the authentic product based on a product feature of the authentic product and a product feature of the received product. Specifically, when having acquired the product feature of the received product from the purchaser device 20 of the purchaser, the product identification unit 112 collates the acquired product feature of the received product with the product feature of the authentic product acquired from the seller device 10 of the seller in advance, and identifies whether the received product matches the authentic product based on the collation. For example, when having acquired the product feature of the received product from the purchaser device 20 of the purchaser, the product identification unit 112 identifies whether the received product matches the authentic product by collating with the product feature of the authentic product registered in a product identification information database 121.

In addition, the product identification unit 112 identifies whether the received product matches the authentic product based on the product feature extracted for each resolution of a captured image of the authentic product and based on the product feature extracted for each resolution of a captured image of the received product. Specifically, the product identification unit 112 identifies whether the received product matches the authentic product based on the feature of each section of a plurality of sections obtained by dividing the captured image of the authentic product and based on the feature of each section of a plurality of sections obtained by dividing the captured image of the received product. For example, the product identification unit 112 collates the feature of each section of a plurality of sections obtained by dividing the captured image of the received product with the feature of each section of the image of the authentic product registered in the product identification information database 121, and identifies whether the received product matches the authentic product based on the collation.

In addition, the product identification unit 112 identifies whether the received product matches the authentic product based on the feature of the target frame, which is a section including a feature with high distinguishability determined based on the feature of each section of the authentic product, and based on the feature of the target frame, which is a section including a feature with high distinguishability determined based on the feature of each section of the received product. For example, the product identification unit 112 collates the feature of the target frame of the received product with the feature of the target frame of the authentic product registered in the product identification information database 121, and identifies whether the received product matches the authentic product based on the collation.

In addition, the product identification unit 112 identifies whether the received product matches the authentic product based on a product feature extracted from an image included in the product video obtained by imaging the authentic product and based on a product feature extracted from an image included in the product video obtained by imaging the received product. For example, the product identification unit 112 collates a product feature extracted from a captured image of a front surface of the authentic product, a side surface of the authentic product, or a back surface of the authentic product from a product video obtained by imaging a full circle around the authentic product with a product feature extracted from a captured image of a front surface of the received product, a side surface of the received product, or a back surface of the received product from a product video obtained by imaging a full circle around the received product, and identifies whether the received product matches the authentic product based on the collation.

The guidance unit 113 guides the seller or the purchaser to image a portion of the product having higher distinguishability. Specifically, the guidance unit 113 outputs information prompting imaging of a target frame, which is a section including a feature with higher distinguishability, to the seller device 10 of the seller or the purchaser device 20 of the purchaser based on the feature of each section of a plurality of sections obtained by dividing an image of the product.

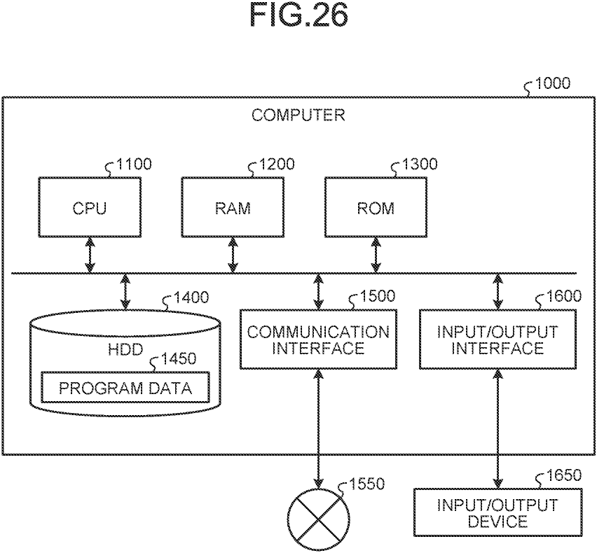

Furthermore, when the product identification unit 112 has identified that the received product matches the authentic product, the guidance unit 113 prompts the purchaser to input product information related to the authentic product received by the purchaser. Specifically, the guidance unit 113 refers to a product information database 123, and outputs information prompting the purchaser to input product information related to a blank item among individual items storing product information related to the authentic product. For example, as illustrated in FIG. 25 to be described below, the guidance unit 113 outputs, to the screen of the purchaser device 20, content C1 including a message prompting the user to input information to a predetermined item, an information input field F1, a button B1 for transmitting input information to the information processing apparatus 100, and a button B2 for skipping input of information.

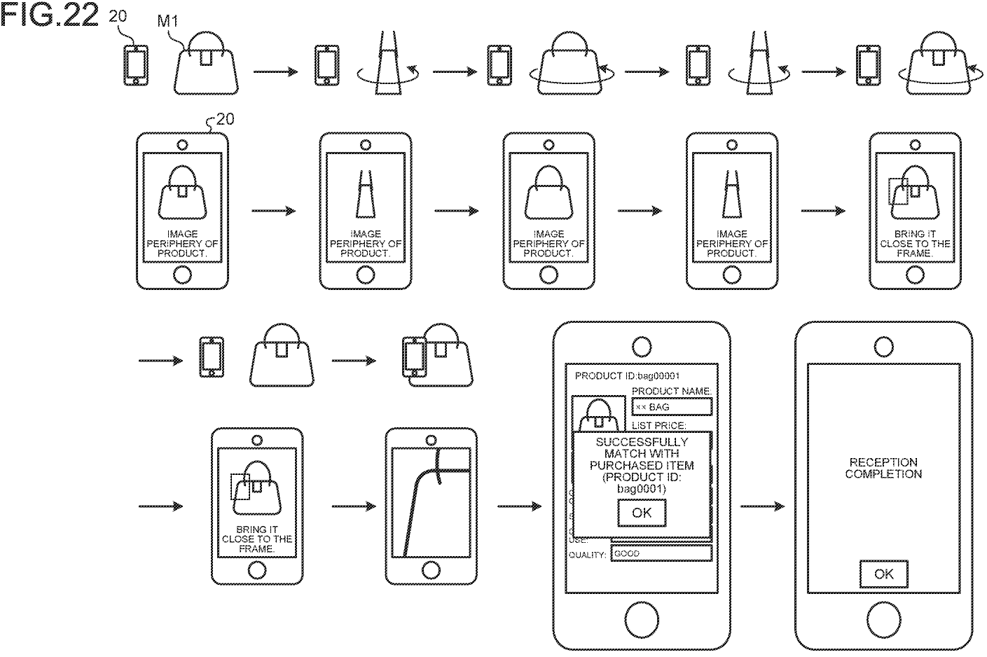

The output unit 114 outputs an identification result obtained by the product identification unit 112 to the purchaser device of the purchaser. For example, when the received product matches the authentic product as a result of the identification by the product identification unit 112, the output unit 114 outputs, on the screen, a message indicating that the authentic product identified by the product ID matches the received product, that is, the product identification is successful, as illustrated in FIG. 22.

The acquisition unit 115 acquires product identification information identifying the authentic product, personal authentication information of the seller and the purchaser, product information related to the authentic product, and product trade information indicating a transaction state of the authentic product. Specifically, the acquisition unit 115 acquires the product identification information identifying the authentic product from the seller device 10. The acquisition unit 115 acquires the personal authentication information of the seller from the seller device 10. The acquisition unit 115 acquires the personal authentication information of the purchaser from the purchaser device 20. In addition, the acquisition unit 115 acquires the product information regarding the authentic product from the purchaser device 20. For example, the acquisition unit 115 acquires product information regarding a blank item from the purchaser device 20 of the purchaser. Note that the acquisition unit 115 may acquire the product information related to the authentic product from the seller device 10. In addition, the acquisition unit 115 acquires the product trade information indicating the transaction state of the authentic product from the seller device 10 or the purchaser device 20.

The storage unit 116 stores the product identification information, the personal authentication information, the product information, and the product trade information acquired by the acquisition unit 115. Specifically, the storage unit 116 stores the product identification information acquired by the acquisition unit 115 in the product identification information database 121. The storage unit 116 stores the personal authentication information acquired by the acquisition unit 115 in the personal authentication information database 122. The storage unit 116 stores the product information acquired by the acquisition unit 115 in the product information database 123. In addition, the storage unit 116 stores the product trade information acquired by the acquisition unit 115 in a product trade information database 124. Furthermore, as illustrated in FIG. 19 to be described below, the storage unit 116 may store the product identification information, the personal authentication information, the product information, and the product trade information by using a blockchain technology.

The update unit 117 updates the blank item related to another authentic product of the same type as the authentic product with the product information related to the blank item acquired by the acquisition unit 115.

The database function 120 is implemented by semiconductor memory elements such as random access memory (RAM) and flash memory, or other storage devices such as a hard disk or an optical disc. As illustrated in FIG. 5, the database function 120 includes the product identification information database 121, the personal authentication information database 122, the product information database 123, and the product trade information database 124.

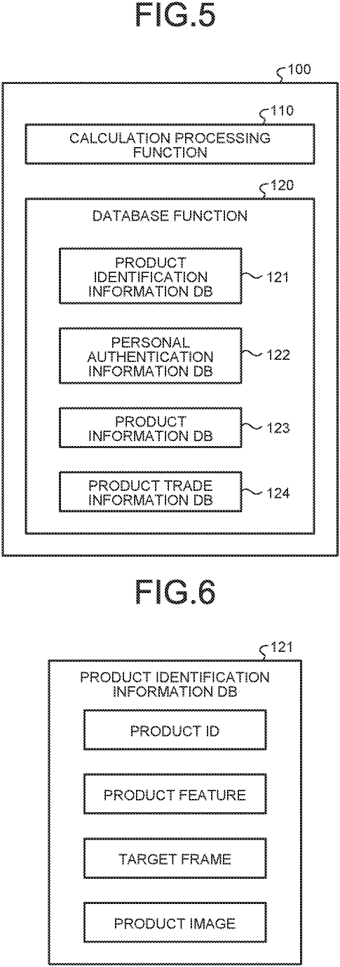

Next, a product identification information database according to the embodiment of the present disclosure will be described with reference to FIG. 6. FIG. 6 is a diagram illustrating an example of the product identification information database according to the embodiment of the present disclosure. As illustrated in FIG. 6, the product identification information database 121 stores information such as a product ID, a product feature, a target frame, and a product image.

The product ID represents identification information identifying a product included in the product video. The product feature represents a feature extracted for each resolution of image data included in the product video. For example, the product feature represents a feature of each section of a plurality of sections obtained by dividing image data included in the product video. The target frame represents coordinate information regarding the target frame. The product image represents a product video. The product identification information database 121 may store coordinate information regarding each section other than the target frame in addition to the coordinate information regarding the target frame.

The product information database 123 stores various types of information related to products. Specifically, as illustrated in FIG. 25 to be described below, the product information database 123 stores information obtained by requesting an input from a seller or a purchaser at the time of product registration (examples of the information include brand name, product category, size, years of use, and quality)

The product trade information database 124 stores various types of information regarding trade of a product. Specifically, the product trade information database 124 stores information indicating a transaction state (for example, in the state of being posted for selling, in reception, etc.) of the product.

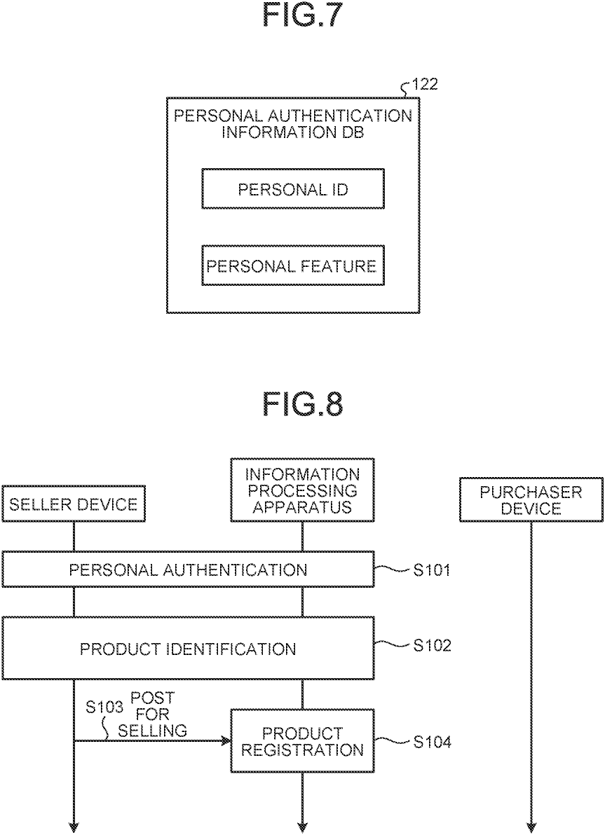

Next, a personal authentication information database according to the embodiment of the present disclosure will be described with reference to FIG. 7. FIG. 7 is a diagram illustrating an example of a personal authentication information database according to the embodiment of the present disclosure. As illustrated in FIG. 7, the personal authentication information database 122 stores information such as a personal ID and a personal feature. The personal ID indicates identification information identifying a user who is a seller or a purchaser. The personal feature indicates personal authentication information of the seller or the purchaser. Specifically, the personal feature is biometric information of the seller or the purchaser, such as fingerprint information, iris information, or face information.

In this manner, the information processing apparatus 100 further includes: the acquisition unit that acquires the product identification information identifying an authentic product, the personal authentication information regarding the seller and the purchaser, the product information related to the authentic product, and the product trade information indicating the transaction state of the authentic product; and the storage unit that stores the product identification information, the personal authentication information, the product information, and the product trade information acquired by the acquisition unit.

### 5. Operation Example of Information Processing System]

### 5-1. Selling Process]

Next, a selling process according to the embodiment of the present disclosure will be described with reference to FIG. 8. FIG. 8 is a sequence diagram illustrating an example of the selling process according to the embodiment of the present disclosure. The selling process starts when the seller first operates the seller device 10 and activates a function for selling.

The seller device 10 acquires personal authentication information of the seller by the personal authentication information acquisition function 13. The personal authentication information is preferably a fingerprint, but may be a face, an iris, and the like, not limited to the fingerprint. The seller device 10 performs the personal authentication by collating the acquired personal authentication information with the preregistered personal authentication information (step S101). When the acquired personal authentication information matches the preregistered personal authentication information, the seller device 10 determines that the personal authentication is successful. When the personal authentication is successful, the seller device 10 transmits the personal authentication information of the seller to the information processing apparatus 100. When having acquired the personal authentication information from the seller device 10, the information processing apparatus 100 registers the acquired personal authentication information in the personal authentication information database 122. Meanwhile, when having acquired the personal authentication information of the seller from the seller device 10 in the personal authentication at the time of the second and subsequent selling, the information processing apparatus 100 performs personal authentication by collating the acquired personal authentication information with the personal authentication information of the seller registered in the personal authentication information database 122 in association with the seller ID. In addition, the acquisition of the personal authentication information may be performed simultaneously with the imaging of the product video for product identification. Variations of the personal authentication acquisition device and the video imaging device at this time will be described with reference to FIG. 10 described below.

Subsequently, the seller device 10 images a product video regarding the product by the product identification information acquisition function 12. Subsequently, the seller device 10 extracts a feature of image data included in the product video by the product identification information acquisition function 12. In addition, the seller device 10 divides the image data into a plurality of sections by the product identification information acquisition function 12 and extracts a feature for each section. Subsequently, the seller device 10 transmits the product video, the product feature, and the product identification information related to the section to the information processing apparatus 100. The information processing apparatus 100 acquires the product identification information from the seller device 10. When having acquired the product identification information, the information processing apparatus 100 collates the acquired product identification information with the product identification information registered in the product identification information database 121 to perform product identification (step S102).

When having determined that the acquired product identification information does not exist in the registration information as a result of the product identification, the information processing apparatus 100 accepts the product posted for selling (step S103). Subsequently, the information processing apparatus 100 registers the product posted for selling (step S104).

As described above, the information processing apparatus 100 includes the personal authentication unit 111 that performs personal authentication of the seller. Specifically, when having acquired the personal authentication information of the seller from the seller device 10 of the seller, the personal authentication unit 111 collates the acquired personal authentication information of the seller with the personal authentication information of the seller acquired in advance from the seller device 10 of the seller, and performs personal authentication of the seller based on the collation. In this manner, the information processing apparatus 100 confirms the identity of the seller at the time of posting the product for selling, making it possible to guarantee the credibility of the seller.

### 5-2. Reception Process]

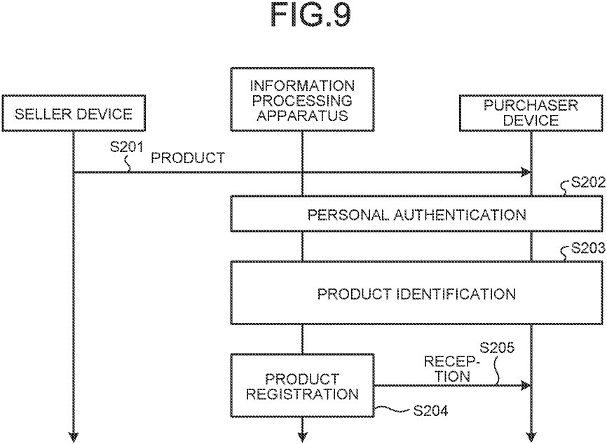

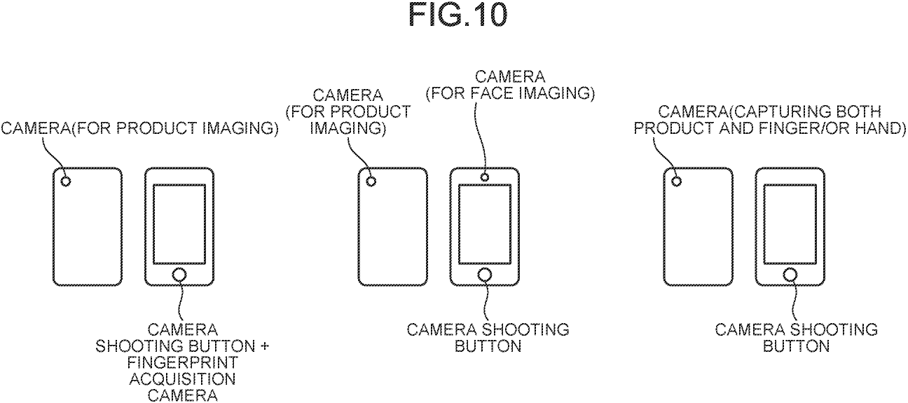

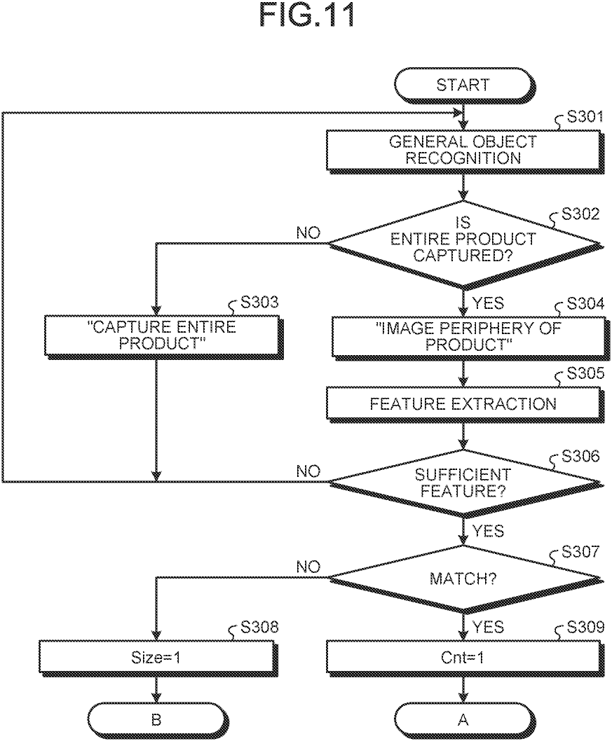

Next, a reception process according to the embodiment of the present disclosure will be described with reference to FIG. 9. FIG. 9 is a sequence diagram illustrating an example of the reception process according to the embodiment of the present disclosure. The reception process starts when the purchaser receives the product sent from the seller and activates a function for reception (step S201).

The purchaser device 20 acquires the personal authentication information of the purchaser by the personal authentication information acquisition function 23. The purchaser device 20 performs personal authentication by collating the acquired personal authentication information with the preregistered personal authentication information (step S202). When the acquired personal authentication information matches the preregistered personal authentication information, the purchaser device 20 determines that the personal authentication is successful. When the personal authentication is successful, the purchaser device 20 transmits the personal authentication information of the purchaser to the information processing apparatus 100. When having acquired the personal authentication information from the purchaser device 20, the information processing apparatus 100 registers the acquired personal authentication information in the personal authentication information database 122 in association with the purchaser ID. Furthermore, hen having acquired the personal authentication information of the purchaser from the purchaser device 20 in the personal authentication at the second or subsequent reception, the information processing apparatus 100 performs personal authentication by collating the acquired personal authentication information with the personal authentication information of the purchaser registered in the personal authentication information database 122 in association with the purchaser ID.

Subsequently, by using the product identification information acquisition function 22, the purchaser device 20 images a product video regarding the product that has been received (hereinafter, also referred to as a received product). Subsequently, the purchaser device 20 extracts a feature of the image data included in the product video by the product identification information acquisition function 22. In addition, the purchaser device 20 divides the image data into a plurality of sections by the product identification information acquisition function 22 and extracts a feature for each section. Subsequently, the purchaser device 20 transmits the product video, the product feature, and the product identification information related to the section to the information processing apparatus 100. The information processing apparatus 100 acquires the product identification information from the purchaser device 20. When having acquired the product identification information, the information processing apparatus 100 collates the acquired product identification information with the product identification information registered in the product identification information database 121 and performs product identification based on the collation (step S203).

When having determined that the acquired product identification information does not exist in the registration information as a result of the product identification, the information processing apparatus 100 outputs an error to the purchaser device 20 and ends the process. In contrast, when having determined that the acquired product identification information exists in the registration information as a result of the product identification, and when the latest record of the product trade information for the product indicates a state of being posted for selling, the information processing apparatus 100 performs product registration of updating the product trade information (information update) of the product to the reception state (step S204). When the product registration (information update) by the information processing apparatus 100 is completed, the reception process by the purchaser ends (step S205).

As described above, the information processing apparatus 100 includes the personal authentication unit 111 that performs personal authentication of the purchaser. Specifically, when having acquired the personal authentication information of the purchaser from the purchaser device 20 of the purchaser, the personal authentication unit 111 performs personal authentication of the purchaser by collating the acquired personal authentication information of the purchaser with the personal authentication information of the purchaser acquired in advance from the purchaser device 20 of the purchaser. In this manner, the information processing apparatus 100 confirms the identity of the purchaser at the time of receiving the product, making it possible to guarantee the credibility of the purchaser.

### 5-3. Personal Authentication Information Acquisition Process]

Next, a configuration of the personal authentication information acquisition function according to the embodiment of the present disclosure will be described with reference to FIG. 10. FIG. 10 is a diagram illustrating a configuration example of a personal authentication information acquisition function according to the embodiment of the present disclosure. As illustrated in FIG. 10, there are many types of variations in the personal authentication acquisition device and the video imaging device. In FIG. 10, a case where the seller device 10 or the purchaser device 20 is a smartphone will be described.

In the example illustrated on the left side of FIG. 10, a product video is captured by a small camera mounted on the back side of the smartphone. In addition, fingerprint data of the user is acquired by a button for imaging a camera mounted on the front side of the smartphone simultaneously with the imaging of the product video.

In the example illustrated in the center of FIG. 10, a product video is captured by a small camera mounted on the back side of the smartphone. In addition, the face data and the iris data of the user are acquired by a small camera mounted on the upper part of the front side of the smartphone simultaneously with the imaging of the product video. In addition, fingerprint data of the user may be acquired by a button for imaging a camera mounted on the front side of the smartphone simultaneously with the imaging of the product video.

In the example illustrated on the right side of FIG. 10, both the product video and the user’s fingers are captured by a small camera mounted on the back side of the smartphone. In addition, fingerprint data of the user is acquired by a button for imaging a camera mounted on the front side of the smartphone simultaneously with the imaging of the product video.

In this manner, since the information processing apparatus 100 can acquire the personal authentication information simultaneously with the imaging of the product video, it is possible to reduce the burden on the user regarding the personal authentication. This makes it possible to improve the usability in the secondary distribution service.

### 5-4. Product Identification Process]

Next, the product identification process according to the embodiment of the present disclosure will be described with reference to FIG. 11. FIG. 11 is a flowchart illustrating an example of the product identification process according to the embodiment of the present disclosure. The product identification process is performed by the seller device 10 and the information processing apparatus 100, or by the purchaser device 20 and the information processing apparatus 100. However, FIGS. 11 to 18 will describe a case where the product identification process is performed by the seller device 10 and the information processing apparatus 100.

The product identification process starts with placing the entire product. The seller device 10 acquires image data at a predetermined time from the product video, and performs recognition processing on the acquired image data using a general object recognition technology (step S301). For example, the seller device 10 identifies a rough category of the product included in the image based on the feature extracted from the image data including the entire product.

The seller device 10 determines whether the entire product has been captured based on the recognition result (step S302). When having determined that the entire product has not been captured (step S302; No), the seller device 10 displays, on a screen, a message prompting to image the entire product as illustrated in FIG. 12 (step S303).

Here, a guidance process according to the embodiment of the present disclosure will be described with reference to FIG. 12. FIG. 12 is a diagram illustrating an example of the guidance process according to the embodiment of the present disclosure. As illustrated on the left side of FIG. 12, when having determined that only a part of the product M1 has been captured (the entire product M1 has not been captured) as a result of the recognition processing on the image, the seller device 10 displays an image G11 including a message “Capture entire product”. In this manner, when the entire product is not placed, the seller device 10 notifies the seller of the fact and prompts the user to correct the manner of imaging. As a result, as illustrated on the right side of FIG. 12, the seller who read the message corrects the manner of imaging, and the seller device 10 acquires an image G12 obtained by capturing the entire product M1.

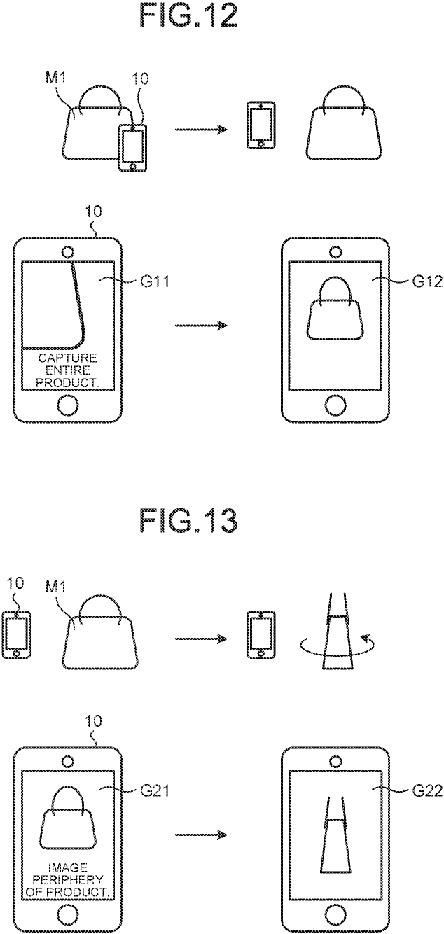

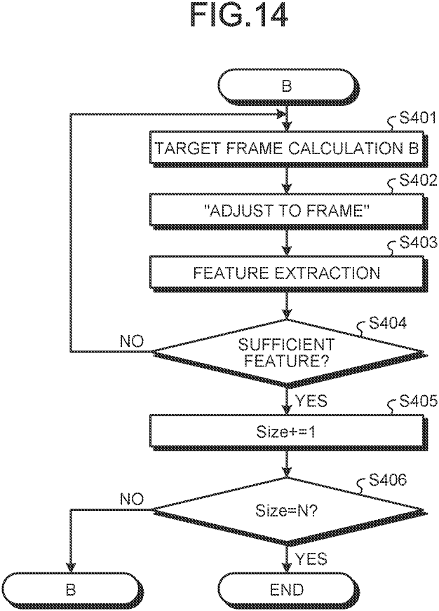

Returning to the description of FIG. 11. In contrast, when having determines that the entire product has been captured (step S302; Yes), the seller device 10 displays, on the screen, a message prompting to image the periphery of the product as illustrated in FIG. 13, (step S304).

Here, the guidance process according to the embodiment of the present disclosure will be described with reference to FIG. 13. FIG. 13 is a diagram illustrating an example of the guidance process according to the embodiment of the present disclosure. As illustrated on the left side of FIG. 13, when having determined that the entire product M1 has been captured as a result of the recognition processing on the image, the seller device 10 displays an image G21 including a message “Capture the periphery of the product”. In this manner, when the entire product has been placed, the seller device 10 prompts the seller to capture the periphery. As a result, as illustrated on the right side of FIG. 13, the seller who read the message images the periphery of the product M1 (for example, a side surface of the product M1), and the seller device 10 acquires an image G22 obtained by capturing the periphery of the product M1 (for example, the side surface of the product M1). Simultaneously with this, the seller device 10 extracts features of the product from the image G21 and the image G22.

Returning to the description of FIG. 11. The seller device 10 extracts a feature from a captured image of the entire product or a captured image of the periphery of the product (step S305). Subsequently, when extracting the feature, the seller device 10 determines whether a sufficient feature has been obtained (step S306). For example, the seller device 10 collates the acquired features with each other, and determines that a sufficient feature has been obtained when the number of features does not increase any more excluding duplicated counting. When the seller device 10 determines that the sufficient feature has not been obtained (step S306; No), the process returns to step S301.

In contrast, when having determined that a sufficient feature has been obtained (step S306; Yes), the seller device 10 transmits the obtained feature to the information processing apparatus 100. When having acquired the feature from the seller device 10, the information processing apparatus 100 determines whether the acquired feature matches the feature of each product registered in the product identification information database 121 (step S307).

When having determined that the acquired feature does not match the feature of each product registered in the product identification information database 121 (step S307; No), the information processing apparatus 100 sets the counter value to 1 (step S308), and the process proceeds to process B. Note that process B will be described in detail with reference to FIG. 14 described below.

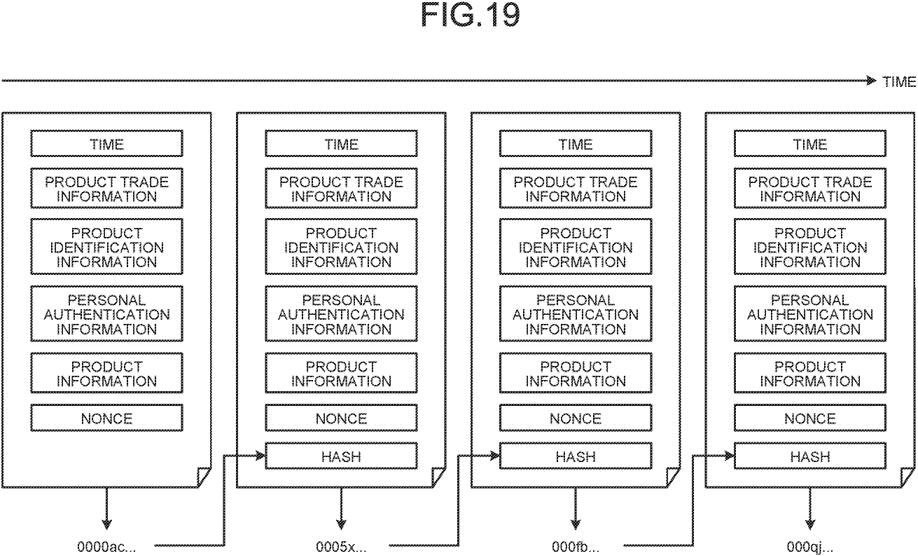

In contrast, when having determined that the acquired feature matches the feature of the product registered in the product identification information database 121 (step S307; Yes), the information processing apparatus 100 sets the counter value to 1 (step S309), and the process proceeds to process A. Note that process A will be described in detail with reference to FIG. 17 described below.

Next, the product identification process according to the embodiment of the present disclosure will be described with reference to FIG. 14. FIG. 14 is a flowchart illustrating an example of the product identification process according to the embodiment of the present disclosure. FIG. 14 is a flowchart illustrating an example of process B in a case where the feature acquired from the captured image of the product does not match the feature of each product registered in the product identification information database 121.

In the process B, the seller device 10 first calculates the frame of the target in order to gradually acquire the feature with higher resolution of the product (step S401). For example, the seller device 10 divides the central portion of the product image into a mesh and calculates the feature of each part of the mesh. Subsequently, the seller device 10 calculates similarity between the calculated features, and determines a part of the mesh having a feature that is not similar to any of the calculated features as the target frame. For example, the seller device 10 identifies individual products based on the feature of the target frame.

Here, the target frame determination process according to the embodiment of the present disclosure will be described with reference to FIG. 15. FIG. 15 is a diagram illustrating an example of target frame determination processing according to the embodiment of the present disclosure. As illustrated on the left side of FIG. 15, the seller device 10 displays an image G31 of a product having a feature not matching the feature of each product registered in the product identification information database 121. As illustrated in the center of FIG. 15, the seller device 10 divides the central portion of the image into a mesh and calculates the feature of each part of the mesh. At this time, the seller device 10 displays an image G32 in which a mesh MS1 is superimposed on the product image. Subsequently, the seller device 10 calculates similarity between the calculated features, and determines a part of the mesh having a feature that is not similar to any of the calculated features as a target frame T1. As illustrated on the right side of FIG. 15, the seller device 10 displays an image G33 in which the target frame T1 is superimposed on the product image.

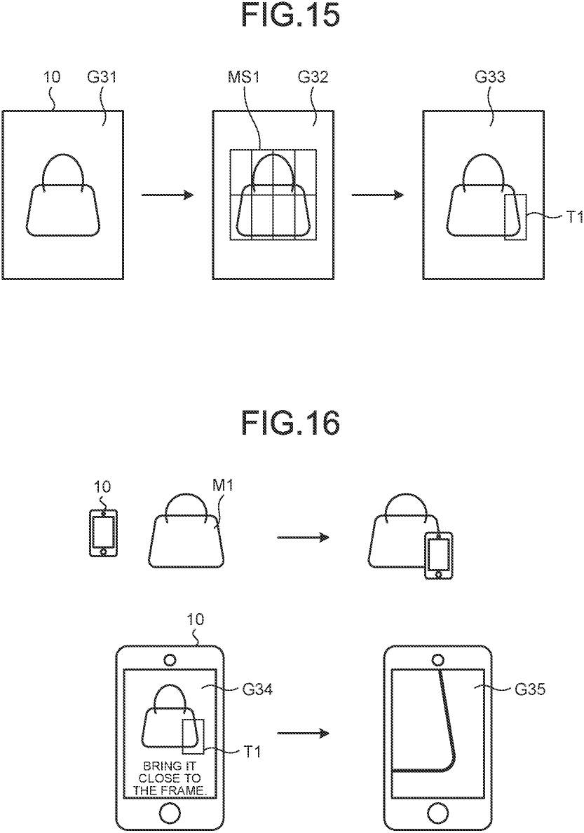

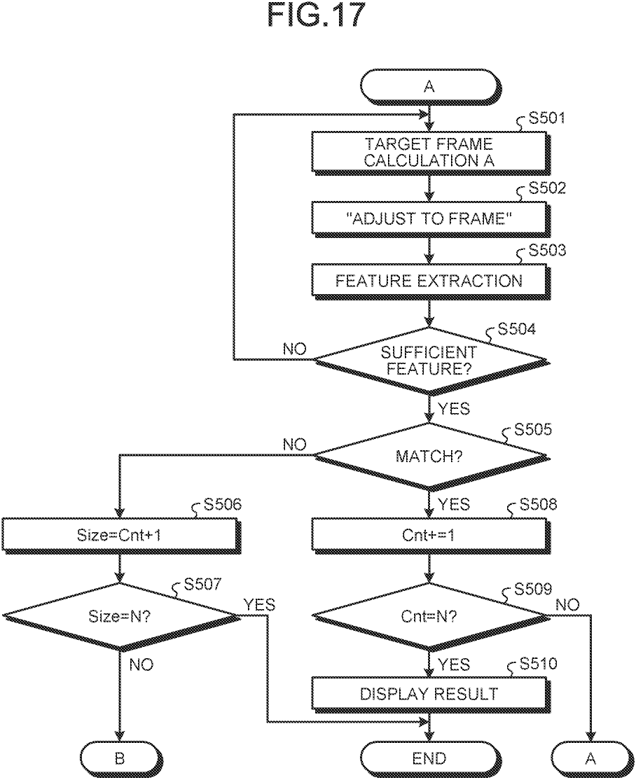

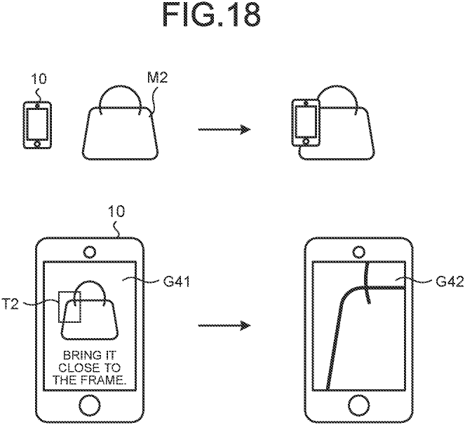

Returning to the description of FIG. 14. When having determined the target frame, the seller device 10 displays, on the screen, a message prompting the user to bring the camera close to the target frame to perform imaging as illustrated in FIG. 16 (step S402).

Here, the guidance process according to the embodiment of the present disclosure will be described with reference to FIG. 16. FIG. 16 is a diagram illustrating an example of the guidance process according to the embodiment of the present disclosure. As illustrated on the left side of FIG. 16, when having determined the target frame T1, the seller device 10 displays an image G34 including a product on which the target frame T1 is superimposed and a message “Bring it close to the frame”. In this manner, the seller device 10 displays the determined target frame to the user and prompts the user to increase the resolution of the product image. As a result, as illustrated on the right side of FIG. 16, the seller who read the message brings the camera close to the target frame and captures an image, so as to allow the seller device 10 to acquire an image G35 captured as an enlarged portion of the product corresponding to the target frame. At this time, the seller device 10 simultaneously extracts the feature of the product from the image G35.

Returning to the description of FIG. 14. The seller device 10 extracts the feature of the product from the image captured as an enlarged portion of the product corresponding to the target frame (step S403). Subsequently, after extracting the feature, the seller device 10 determines whether a sufficient feature has been obtained (step S404). For example, the seller device 10 collates the acquired features with each other, and determines that a sufficient feature has been obtained when the number of features does not increase any more excluding duplicated counting. When the seller device 10 determines that the sufficient feature has not been obtained (step S404; No), the process returns to step S401.

In contrast, when having determined that a sufficient feature has been obtained (step S404; Yes), the seller device 10 increments the counter value by 1 (step S405). The seller device 10 performs the above by loop calculation and gradually increases the resolution. The seller device 10 determines whether the counter finally reaches a prescribed value (step S406). When having determined that the counter has reached the prescribed value (step S406; Yes), the seller device 10 ends process B. In contrast, when having determined that the counter has not reached the prescribed value (step S406; No), the seller device 10 repeats process B. As a result, process B is used to obtain a result that there is no matching product in the registered products, and the target frame and the feature at each resolution scale.

Next, the product identification process according to the embodiment of the present disclosure will be described with reference to FIG. 17. FIG. 17 is a flowchart illustrating an example of the product identification process according to the embodiment of the present disclosure. FIG. 17 is a flowchart illustrating an example of process A in a case where the feature amount acquired from the captured image of the product matches the feature amount of the product registered in the product identification information database 121.

The seller device 10 reads the target frame of the registered product having a matching feature, and calculates the target frame of the captured image of the product (step S501). For example, the seller device 10 calculates similarity between the feature of the target frame of the registered product with the matching feature and the feature of each section of the captured image of the product. Subsequently, the seller device 10 determines a section having a feature having a highest similarity to the feature of the target frame of the registered product as the target frame of the captured image of the product. Next, having determined the target frame, the seller device 10 displays, on the screen, a message prompting the user to bring the camera close to the target frame to perform imaging as illustrated in FIG. 18 (step S502).

Here, the guidance process according to the embodiment of the present disclosure will be described with reference to FIG. 18. FIG. 18 is a diagram illustrating an example of the guidance process according to the embodiment of the present disclosure. As illustrated on the left side of FIG. 18, when having determined a target frame T2, the seller device 10 displays an image G41 including a product on which the target frame T2 is superimposed and a message “Bring it close to the frame”. In this manner, the seller device 10 displays the determined target frame to the user and prompts the user to increase the resolution of the product image. As a result, as illustrated on the right side of FIG. 18, the seller who read the message brings the camera close to the target frame and captures an image, so as to allow the seller device 10 to acquire an image G42 captured as an enlarged portion of the product corresponding to the target frame. At this time, the seller device 10 simultaneously extracts the feature of the product from the image G42.

Returning to the description of FIG. 18. The seller device 10 extracts the feature of the product from the image captured as an enlarged portion of the product corresponding to the target frame (step S503). Subsequently, after extracting the feature, the seller device 10 determines whether a sufficient feature has been obtained (step S504). For example, the seller device 10 collates the acquired features with each other, and determines that a sufficient feature has been obtained when the number of features does not increase any more excluding duplicated counting. When the seller device 10 determines that the sufficient feature has not been obtained (step S504; No), the process returns to step S501.

In contrast, when having determined that a sufficient feature has been obtained (step S504; Yes), the seller device 10 acquires, from the information processing apparatus 100, the feature of the registered product registered in the product identification information database 121. When having acquired the feature from the information processing apparatus 100, the seller device 10 determines whether the obtained feature matches the feature of the registered product (step S505). When having determined that the obtained feature matches the feature of the registered product (step S505; Yes), the seller device 10 increments the counter value by 1 (step S508). The seller device 10 performs the above by loop calculation and gradually increases the resolution. The seller device 10 determines whether the counter finally reaches a prescribed value (step S509). When having determined that the counter has reached the prescribed value (step S509; Yes), the seller device 10 displays a product identification result indicating that the imaged product is the same product as the registered product (step S510). For example, the seller device 10 displays information regarding the registered product, such as a product ID, a product name, a manufacturer, a category, and a size. After displaying the determination result, the seller device 10 ends process A. In contrast, when having determined that the counter has not reached the prescribed value (step S509; No), the seller device 10 repeats process A.

In contrast, when having determined that the obtained feature does not match the feature of the registered product (step S505; No), the seller device 10 sets a value obtained by adding 1 to the previous counter value as the counter value of process B (step S506). Subsequently, the seller device 10 determines whether the counter value has reached the prescribed value (step S507). When the seller device 10 determines that the counter value has reached the prescribed value (step S507; Yes), the process A ends. In contrast, when the seller device 10 determines that the counter value has not reached the prescribed value (step S507; No), the process proceeds to process B. As a result, in a case where the process proceeds to the end of process A to complete process A, it is possible to obtain a result that there is a matching product in the registered products, as well as the target frame and the feature at each resolution scale.

As described above, the information processing apparatus 100 includes the product identification unit 112 that identifies whether a received product received by a purchaser of an authentic product posted for selling by the seller who has undergone the personal authentication matches the authentic product based on a product feature of the authentic product and a product feature of the received product. Specifically, the product identification unit 112 identifies whether the received product matches the authentic product based on a product feature extracted for each resolution of the captured image of the authentic product and based on a product feature extracted for each resolution of the captured image of the received product. For example, when having acquired the product feature of the received product from the purchaser device of the purchaser, the product identification unit 112 collates the acquired product feature of the received product with the product feature of the authentic product acquired from the seller device of the seller in advance, and identifies whether the received product matches the authentic product based on the collation.

In this manner, according to the embodiment of the present disclosure, confirmation as to whether the received product is an authentic product when receiving the product is performed, making it possible to prevent the purchaser from receiving a non-authentic product. That is, according to the embodiment of the present disclosure, it is possible to prevent distribution of counterfeit products. This makes it possible to improve the usability in the secondary distribution service.

In addition, the information processing apparatus 100 further includes the guidance unit 113 that guides the seller or the purchaser to image a portion of the product having higher distinguishability. Specifically, the guidance unit 113 outputs information prompting imaging of a target frame, which is a section including a feature with higher distinguishability, to the seller device 10 or the purchaser device 20 based on the feature of each section of a plurality of sections obtained by dividing an image of the product. In this manner, according to the embodiment of the present disclosure, it is possible to extract a feature and search for the presence or absence of the product having a matching feature while dynamically guiding the user to the capturing position. This makes it possible to improve the usability in the secondary distribution service.

Furthermore, the information processing apparatus 100 further includes an output unit 114 that outputs an identification result obtained by the product identification unit to the purchaser device 20 of the purchaser. In this manner, according to the embodiment of the present disclosure, since the identification result is presented to the user, it is possible to improve the reliability of the user for the secondary distribution service.

### 5-5. Data Recording Process]

Next, a data recording process according to the embodiment of the present disclosure will be described with reference to FIG. 19. FIG. 19 is a diagram illustrating an example of a data recording process according to the embodiment of the present disclosure. Although FIG. 5 illustrates an example in which the product identification information, the personal authentication information, the product information, and the product trade information are stored in the database function 120 of the information processing apparatus 100, recording of information is not limited thereto. Specifically, as illustrated in FIG. 19, the product identification information, the personal authentication information, the product information, and the product trade information may be recorded using the blockchain technology. In this manner, the storage unit stores the product identification information, the personal authentication information, the product information, and the product trade information using the blockchain technology.

### 5-6. Use Case]

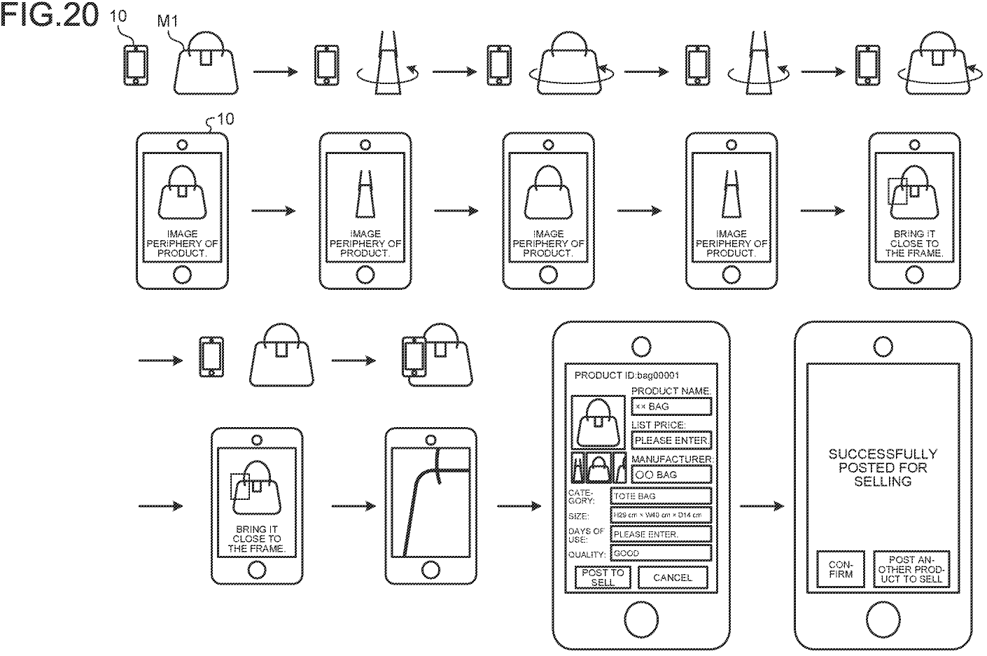

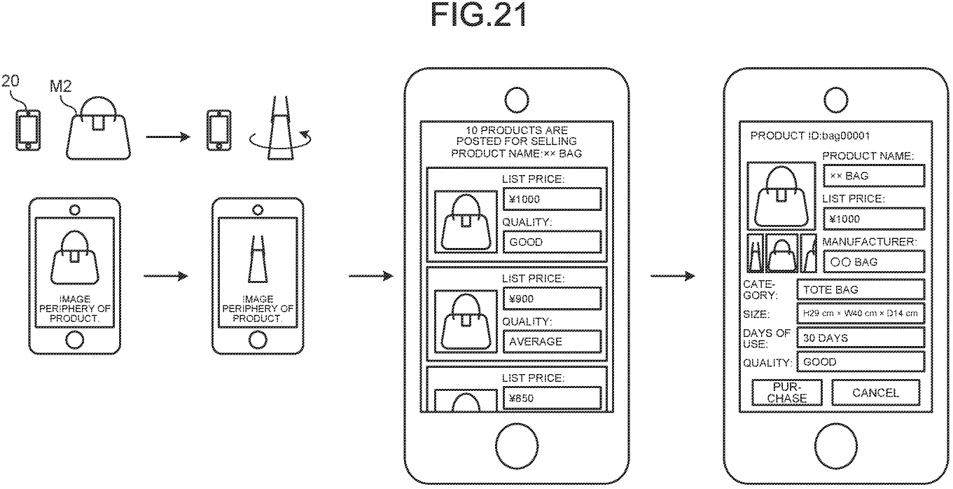

Next, a flow of a selling process according to the embodiment of the present disclosure will be described with reference to FIG. 20. FIG. 20 is a diagram illustrating an example of a flow of the selling process according to the embodiment of the present disclosure. In the example illustrated in FIG. 20, when the seller tries to post the bag to sell, the seller activates the selling function on the seller device 10 and starts imaging of the bag. Imaging is performed in accordance with instructions as illustrated in the upper part to the middle of the lower part of FIG. 20. In this example, an instruction is initially made to capture an image of the periphery of the bag, and then, a characteristic portion of the bag is detected, and the seller is guided to capture a close-up image of the portion.

FIG. 20 illustrates a case where there is no registered product that strictly matches the feature acquired from the image although the product partially matches the feature. In this case, the posting of the product for selling is permitted, the product ID is assigned to the product, and a selling data input screen is displayed. At this time, information such as a product name, a manufacturer, a category, and a size is automatically input from product data of the partially matched product (that is, a product of the same type). The seller inputs remaining information (list price, number of days of use, and quality) and presses a post to sell button to complete the selling process.

Next, a flow of a purchase process according to the embodiment of the present disclosure will be described with reference to FIG. 21. FIG. 21 is a diagram illustrating an example of a flow of the purchase process according to the embodiment of the present disclosure. The example illustrated in FIG. 21 is a case where a product that the purchaser desires is imaged and searched for before purchase. First, the purchaser starts imaging a bag in the same manner as at the time of selling. As illustrated in FIG. 21, the purchaser is guided to capture an image of the periphery of the bag. Since the purpose of this time is purchase, a more detailed feature is not required, and it is sufficient to be able to acquire a feature sufficient for finding the same type of bag. FIG. 21 illustrates a screen example in a case where ten bags are being posted for selling. The purchaser can select a bag that matches his/her conditions from among the bags. FIG. 21 illustrates a case where the bag on the top is selected. The purchaser can determine whether to purchase after viewing the conditions of the bag and the like.

Next, a flow of a reception process according to the embodiment of the present disclosure will be described with reference to FIG. 22. FIG. 22 is a diagram illustrating an example of a flow of the reception process according to the embodiment of the present disclosure. In the example illustrated in FIG. 22, after the bag arrives, the purchaser first activates the reception function of the purchaser device 20 and starts imaging the bag. Imaging is performed in accordance with instructions as illustrated in the upper part to the middle of the lower part of FIG. 22. FIG. 22 assumes that the same bag as the bag illustrated in FIG. 20 has been purchased, and thus, the guidance of imaging should be the same. When the purchaser device 20 acquires a sufficient feature and the matching product information is found in the search, the purchaser is notified that the received product matches the purchased product together with the product information such as the product ID, and the reception process is completed.

### 3. Modification

### 1. Information Input]

Next, a selling process according to a modification will be described with reference to FIG. 23. FIG. 23 is a sequence diagram illustrating an example of the selling process according to the modification. Processes of steps S601 to S604 illustrated in FIG. 23 are the same as the processes of steps S101 to S104 illustrated in FIG. 8, and thus redundant description is omitted. In FIG. 23, when performing registration of a product, the information processing apparatus 100 requests the seller to input information regarding the product (step S605). For example, the information processing apparatus 100 requests input of information for an item to which information has not been input when information regarding the same products is merged. When having obtained the input of the product information from the seller, the seller device 10 transmits the product information to the information processing apparatus 100 (step S606). When having acquired the product information from the seller device 10, the information processing apparatus 100 updates an item having missing input information regarding the same product with the acquired product information.

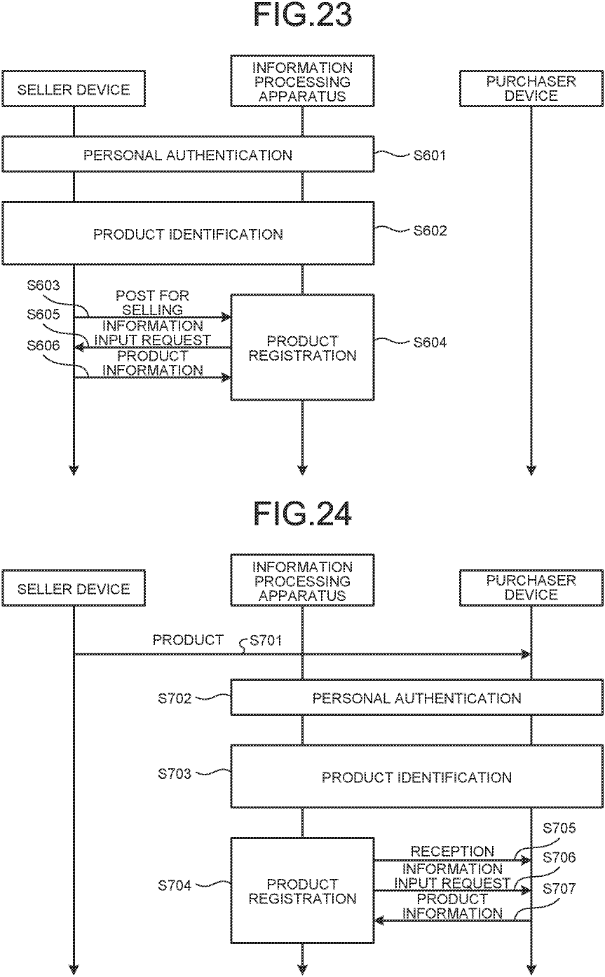

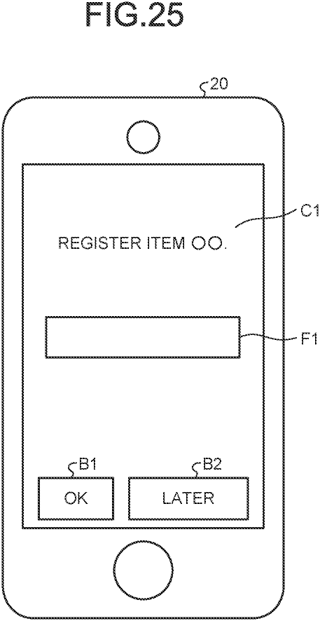

Next, the reception process according to the modification will be described with reference to FIG. 24. FIG. 24 is a sequence diagram illustrating an example of a reception process according to a modification. Processes of steps S701 to S705 illustrated in FIG. 24 are the same as the processes of steps S201 to S205 illustrated in FIG. 9, and thus redundant description is omitted. In FIG. 24, when performing registration of a product, the information processing apparatus 100 requests the purchaser to input information regarding the product (step S706). For example, the information processing apparatus 100 requests input of information for an item to which information has not been input when information regarding the same products is merged. When having obtained the input of the product information from the purchaser, the purchaser device 20 transmits the product information to the information processing apparatus 100 (step S707). When having acquired the product information from the purchaser device 20, the information processing apparatus 100 updates an item having missing input information regarding the same product with the acquired product information.

As described above, the information processing apparatus 100 further includes the guidance unit 113 that prompts the purchaser to input product information related to the authentic product received by the purchaser when the product identification unit has identified that the received product matches the authentic product. The guidance unit 113 outputs, to the purchaser, information prompting input of product information related to a blank item among individual items storing product information related to an authentic product. In addition, the information processing apparatus 100 further includes: the acquisition unit 115 that acquires product information regarding a blank item from the purchaser device of the purchaser; and the update unit 117 that updates the blank item regarding another authentic product of the same type as the authentic product with the product information acquired by the acquisition unit. With this configuration, the information processing apparatus 100 can acquire the latest information even for information that might differ depending on each product, which can occur in secondary distribution in particular, such as conditions of the product (for example, having a scratch, etc.). This makes it possible for the information processing apparatus 100 to improve the reliability for the secondary distribution service from the user.

Next, a screen prompting information input to the user according to the modification will be described with reference to FIG. 25. FIG. 25 is a diagram illustrating an example of a screen prompting a user to input information according to a modification. In an example illustrated in FIG. 25, the purchaser device 20 displays, on the screen, content C1 including a message prompting the user to input information to a predetermined item, an information input field F1, a button B1 for transmitting input information to the information processing apparatus 100, and a button B2 for skipping input of information.

### 2. Product Identification Process]

The product identification process described above may be performed in a form in which the seller device 10 (or the purchaser device 20) and the information processing apparatus 100 sequentially exchange information. However, in a case where information regarding the database function 120 of the information processing apparatus 100 is recorded in a blockchain or the like, data may be downloaded to the seller device 10 (or the purchaser device 20) in advance, and calculation may be performed on the seller device 10 (or the purchaser device 20) side. It is allowable to perform, after the calculation, synchronization of updated data with the information processing apparatus 100.

In addition, although the product identification process described above is an example in which the seller device 10 (or the purchaser device 20) identifies a rough category of products included in the image based on the feature extracted from the image data including the entire product, and then identifies individual products included in the image data based on the feature of the target frame, the identification process is not limited thereto. Specifically, the seller device 10 (or the purchaser device 20) calculates a feature for each resolution of the image data, and identifies the product information included in the image data based on the feature calculated for each resolution. For example, the seller device 10 (or the purchaser device 20) may identify product information such as a product name, a manufacturer, and a size of a product included in the image data based on features of a plurality of parts of mesh forming the image data.

### 4. Summary

As described above, according to each embodiment of the present disclosure, since the identity confirmation of the seller is performed at the time of selling the product, it is possible to guarantee the credibility of the seller. In addition, it is possible to acquire the personal authentication information simultaneously with the imaging of the product video, leading to reduction of the burden on the user regarding the personal authentication. Furthermore, confirmation as to whether the received product is an authentic product is performed at reception of the product, making it possible to prevent the purchaser from receiving a non-authentic product. That is, according to each embodiment of the present disclosure, it is possible to prevent distribution of counterfeit products. This makes it possible to improve the usability in the secondary distribution service.

### 5. Hardware Configuration

The information apparatus such as the information processing apparatus 100 according to the above-described embodiments and modifications are reproduced by a computer 1000 having a configuration as illustrated in FIG. 26, for example. FIG. 26 is a hardware configuration diagram illustrating an example of the computer 1000 that reproduces the functions of the information processing apparatus such as the information processing apparatus 100. Hereinafter, the information processing apparatus 100 according to the embodiment will be described as an example. The computer 1000 includes a CPU 1100, RAM 1200, read only memory (ROM) 1300, a hard disk drive (HDD) 1400, a communication interface 1500, and an input/output interface 1600. Individual components of the computer 1000 are interconnected by a bus 1050.

The CPU 1100 operates based on a program stored in the ROM 1300 or the HDD 1400 so as to control each of components. For example, the CPU 1100 develops the program stored in the ROM 1300 or the HDD 1400 into the RAM 1200 and executes processing corresponding to various programs.

The ROM 1300 stores a boot program such as a basic input output system (BIOS) executed by the CPU 1100 when the computer 1000 starts up, a program dependent on hardware of the computer 1000, or the like.

The HDD 1400 is a non-transitory computer-readable recording medium that records a program executed by the CPU 1100, data used by the program, or the like. Specifically, the HDD 1400 is a recording medium that records an information processing program according to the present disclosure, which is an example of program data 1450.

The communication interface 1500 is an interface for connecting the computer 1000 to an external network 1550 (for example, the Internet). For example, the CPU 1100 receives data from other devices or transmits data generated by the CPU 1100 to other devices via the communication interface 1500.

The input/output interface 1600 is an interface for connecting an input/output device 1650 with the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Furthermore, the input/output interface 1600 may function as a media interface for reading a program or the like recorded on predetermined recording medium (or simply medium). Examples of the media include optical recording media such as a digital versatile disc (DVD) or a phase change rewritable disk (PD), a magneto-optical recording medium such as a magneto-optical disk (MO), a tape medium, a magnetic recording medium, and semiconductor memory.

For example, when the computer 1000 functions as the information processing apparatus 100 according to the embodiment, the CPU 1100 of the computer 1000 executes the information processing program loaded on the RAM 1200 so as to reproduce the functions of the calculation processing function 110 and the like. Furthermore, the HDD 1400 stores the information processing program according to the present disclosure or data in the database function 120. While the CPU 1100 executes program data 1450 read from the HDD 1400, the CPU 1100 may acquire these programs from another device via the external network 1550, as another example.

Note that the present technology can also have the following configurations.

An information processing apparatus comprising:
a personal authentication unit that performs personal authentication of a seller; and
a product identification unit that identifies whether a received product received by a purchaser of an authentic product posted for selling by the seller who has undergone the personal authentication matches the authentic product based on a product feature of the authentic product and a product feature of the received product.

The information processing apparatus according to (1),
wherein the product identification unit
identifies whether the received product matches the authentic product based on a product feature extracted for each resolution of a captured image of the authentic product and based on a product feature extracted for each resolution of a captured image of the received product.

The information processing apparatus according to (1) or (2),
wherein the product identification unit
identifies whether the received product matches the authentic product based on a feature of each section of a plurality of sections obtained by dividing the captured image of the authentic product and based on a feature of each section of a plurality of sections obtained by dividing the captured image of the received product.

The information processing apparatus according to any one of (1) to (3),
wherein the product identification unit
identifies whether the received product matches the authentic product based on a feature of a target frame, which is a section including a feature with high distinguishability determined based on the feature of each section of the authentic product, and based on a feature of a target frame, which is a section including the feature with high distinguishability determined based on the feature of each section of the received product.

The information processing apparatus according to any one of (1) to (4),
wherein the product identification unit
identifies whether the received product matches the authentic product based on a product feature extracted from an image included in a product video obtained by imaging the authentic product and based on a product feature extracted from an image included in a product video obtained by imaging the received product.

The information processing apparatus according to any one of (1) to (5),
wherein, when having acquired the product feature of the received product from a purchaser device of the purchaser, the product identification unit
collates the acquired product feature of the received product with a product feature of the authentic product acquired in advance from a seller device of the seller, and identifies whether the received product matches the authentic product based on the collation.

The information processing apparatus according to any one of (1) to (6),
wherein, when having acquired personal authentication information of the seller from the seller device of the seller, the personal authentication unit
collates the acquired personal authentication information of the seller with the personal authentication information of the seller acquired in advance from the seller device of the seller, and performs personal authentication of the seller based on the collation.

The information processing apparatus according to any one of (1) to (7),
wherein the personal authentication unit
performs personal authentication of the seller based on personal authentication information represented by fingerprint information, iris information, or face information of the seller.

The information processing apparatus according to any one of (1) to (8),
wherein, when having acquired the personal authentication information of the purchaser from the purchaser device of the purchaser, the personal authentication unit
collates the acquired personal authentication information of the purchaser with the personal authentication information of the purchaser acquired in advance from the purchaser device of the purchaser, and performs personal authentication of the purchaser based on the collation.

The information processing apparatus according to any one of (1) to (9),
wherein the personal authentication unit
performs personal authentication of the purchaser based on personal authentication information represented by fingerprint information, iris information, or face information of the purchaser.

The information processing apparatus according to any one of (1) to (10), further comprising
a guidance unit that guides the seller or the purchaser to capture an image of a portion having higher distinguishability in a product,
wherein the guidance unit
outputs, to a seller device of the seller or a purchaser device of the purchaser, information prompting imaging of a target frame, which is a section including a feature with higher distinguishability, based on a feature of each section of a plurality of sections obtained by dividing a captured image of the product.

The information processing apparatus according to any one of (1) to (11), further comprising

an output unit that outputs an identification result obtained by the product identification unit to a purchaser device of the purchaser.

The information processing apparatus according to any one of (1) to (12), further comprising:
an acquisition unit that acquires product identification information identifying the authentic product, personal authentication information regarding the seller and the purchaser, product information related to the authentic product, and product trade information indicating a transaction state of the authentic product; and
a storage unit that stores the product identification information, the personal authentication information, the product information, and the product trade information, acquired by the acquisition unit.

The information processing apparatus according to (13),
wherein the storage unit
stores the product identification information, the personal authentication information, the product information, and the product trade information using a blockchain technology.

The information processing apparatus according to any one of (1) to (14), further comprising
a guidance unit that performs, when the product identification unit has identified that the received product matches the authentic product, an operation of prompting the purchaser to input product information related to the authentic product received by the purchaser,
wherein the guidance unit
outputs, to the purchaser, information prompting an input of product information related to a blank item among items storing the product information related the authentic product.

The information processing apparatus according to (15), further comprising:
an acquisition unit that acquires product information related to the blank item from a purchaser device of the purchaser; and
an update unit that updates the blank item related to another authentic product of the same type as the authentic product with the product information acquired by the acquisition unit.

An information processing method executed by a computer, the method comprising processes of:
performing personal authentication of a seller; and
identifying whether a received product received by a purchaser of an authentic product posted for selling by the seller who has undergone the personal authentication matches the authentic product based on a product feature of the authentic product and a product feature of the received product.

An information processing program for causing a computer to execute processes comprising:
a personal authentication process of performing personal authentication of a seller; and
a product identification process of identifying whether a received product received by a purchaser of an authentic product posted for selling by the seller who has undergone the personal authentication matches the authentic product based on a product feature of the authentic product and a product feature of the received product.

An information processing system comprising a seller device, a purchaser device, and an information processing apparatus,
wherein the seller device
   captures a product video of an authentic product posted for selling by the seller, and extracts a product feature of an image included in the captured product video,
the purchaser device
   captures a product video of a received product received by the purchaser who has purchased the authentic product, and extracts a product feature of the image included in the captured product video, and
the information processing apparatus
   identifies whether the received product matches the authentic product based on the product feature of the authentic product extracted by the seller device and the product feature of the received product extracted by the purchaser device.

The information processing system according to (19),
wherein the seller device
   divides an image included in the captured product video into a plurality of sections, and extracts a product feature for each of the divided sections, and
the purchaser device
   divides an image included in the captured product video into a plurality of sections, and extracts a product feature for each of the divided sections.

### REFERENCE SIGNS LIST

1 INFORMATION PROCESSING SYSTEM
10 SELLER DEVICE
11 CALCULATION FUNCTION
12 PRODUCT IDENTIFICATION INFORMATION ACQUISITION FUNCTION
13 PERSONAL AUTHENTICATION INFORMATION ACQUISITION FUNCTION
14 INPUT/OUTPUT FUNCTION
20 PURCHASER DEVICE
21 CALCULATION FUNCTION
22 PRODUCT IDENTIFICATION INFORMATION ACQUISITION FUNCTION
23 PERSONAL AUTHENTICATION INFORMATION ACQUISITION FUNCTION
24 INPUT/OUTPUT FUNCTION
100 INFORMATION PROCESSING APPARATUS
110 CALCULATION PROCESSING FUNCTION
120 DATABASE FUNCTION
121 PRODUCT IDENTIFICATION INFORMATION DATABASE
122 PERSONAL AUTHENTICATION INFORMATION DATABASE
123 PRODUCT INFORMATION DATABASE
124 PRODUCT TRADE INFORMATION DATABASE

1. An information processing apparatus comprising:
a personal authentication unit that performs personal authentication of a seller; and
a product identification unit that identifies whether a received product received by a purchaser of an authentic product posted for selling by the seller who has undergone the personal authentication matches the authentic product based on a product feature of the authentic product and a product feature of the received product.

2. The information processing apparatus according to claim 1,
wherein the product identification unit
identifies whether the received product matches the authentic product based on a product feature extracted for each resolution of a captured image of the authentic product and based on a product feature extracted for each resolution of a captured image of the received product.

3. The information processing apparatus according to claim 1,
wherein the product identification unit
identifies whether the received product matches the authentic product based on a feature of each section of a plurality of sections obtained by dividing the captured image of the authentic product and based on a feature of each section of a plurality of sections obtained by dividing the captured image of the received product.

4. The information processing apparatus according to claim 1,
wherein the product identification unit
identifies whether the received product matches the authentic product based on a feature of a target frame, which is a section including a feature with high distinguishability determined based on the feature of each section of the authentic product, and based on a feature of a target frame, which is a section including the feature with high distinguishability determined based on the feature of each section of the received product.

5. The information processing apparatus according to claim 1,
wherein the product identification unit
identifies whether the received product matches the authentic product based on a product feature extracted from an image included in a product video obtained by imaging the authentic product and based on a product feature extracted from an image included in a product video obtained by imaging the received product.

6. The information processing apparatus according to claim 1,
wherein, when having acquired the product feature of the received product from a purchaser device of the purchaser, the product identification unit
collates the acquired product feature of the received product with a product feature of the authentic product acquired in advance from a seller device of the seller, and identifies whether the received product matches the authentic product based on the collation.

7. The information processing apparatus according to claim 1,
wherein, when having acquired personal authentication information of the seller from the seller device of the seller, the personal authentication unit
collates the acquired personal authentication information of the seller with the personal authentication information of the seller acquired in advance from the seller device of the seller, and performs personal authentication of the seller based on the collation.

8. The information processing apparatus according to claim 1,
wherein the personal authentication unit
performs personal authentication of the seller based on personal authentication information represented by fingerprint information, iris information, or face information of the seller.

9. The information processing apparatus according to claim 1,
wherein, when having acquired the personal authentication information of the purchaser from the purchaser device of the purchaser, the personal authentication unit
collates the acquired personal authentication information of the purchaser with the personal authentication information of the purchaser acquired in advance from the purchaser device of the purchaser, and performs personal authentication of the purchaser based on the collation.

10. The information processing apparatus according to claim 1,
wherein the personal authentication unit
performs personal authentication of the purchaser based on personal authentication information represented by fingerprint information, iris information, or face information of the purchaser.

11. The information processing apparatus according to claim 1, further comprising
a guidance unit that guides the seller or the purchaser to capture an image of a portion having higher distinguishability in a product,
wherein the guidance unit
outputs, to a seller device of the seller or a purchaser device of the purchaser, information prompting imaging of a target frame, which is a section including a feature with higher distinguishability, based on a feature of each section of a plurality of sections obtained by dividing a captured image of the product.

12. The information processing apparatus according to claim 1, further comprising
an output unit that outputs an identification result obtained by the product identification unit to a purchaser device of the purchaser.

13. The information processing apparatus according to claim 1, further comprising:
an acquisition unit that acquires product identification information identifying the authentic product, personal authentication information regarding the seller and the purchaser, product information related to the authentic product, and product trade information indicating a transaction state of the authentic product; and
a storage unit that stores the product identification information, the personal authentication information, the product information, and the product trade information, acquired by the acquisition unit.

14. The information processing apparatus according to claim 13,
wherein the storage unit
stores the product identification information, the personal authentication information, the product information, and the product trade information using a blockchain technology.

15. The information processing apparatus according to claim 1, further comprising
a guidance unit that performs, when the product identification unit has identified that the received product matches the authentic product, an operation of prompting the purchaser to input product information related to the authentic product received by the purchaser,
wherein the guidance unit
outputs, to the purchaser, information prompting an input of product information related to a blank item among items storing the product information related the authentic product.

16. The information processing apparatus according to claim 15, further comprising:
an acquisition unit that acquires product information related to the blank item from a purchaser device of the purchaser; and
an update unit that updates the blank item related to another authentic product of the same type as the authentic product with the product information acquired by the acquisition unit.

17. An information processing method executed by a computer, the method comprising processes of:
performing personal authentication of a seller; and
identifying whether a received product received by a purchaser of an authentic product posted for selling by the seller who has undergone the personal authentication matches the authentic product based on a product feature of the authentic product and a product feature of the received product.

18. An information processing program for causing a computer to execute processes comprising:
a personal authentication process of performing personal authentication of a seller; and
a product identification process of identifying whether a received product received by a purchaser of an authentic product posted for selling by the seller who has undergone the personal authentication matches the authentic product based on a product feature of the authentic product and a product feature of the received product.

19. An information processing system comprising a seller device, a purchaser device, and an information processing apparatus,
wherein the seller device
captures a product video of an authentic product posted for selling by the seller, and extracts a product feature of an image included in the captured product video,
the purchaser device
captures a product video of a received product received by the purchaser who has purchased the authentic product, and extracts a product feature of the image included in the captured product video, and
the information processing apparatus
identifies whether the received product matches the authentic product based on the product feature of the authentic product extracted by the seller device and the product feature of the received product extracted by the purchaser device.

20. The information processing system according to claim 19,
wherein the seller device
divides an image included in the captured product video into a plurality of sections, and extracts a product feature for each of the divided sections, and
the purchaser device
divides an image included in the captured product video into a plurality of sections, and extracts a product feature for each of the divided sections.
